(19) United States
(12) Patent Application Publication
(10) Pub. No.: US 2013/0141337 A1
(43) Pub. Date: Jun. 6, 2013

(54) KEYPAD FASTENING APPARATUS

(71) Applicant: Samsung Electronics Co., Ltd., Gyeonggi-do (KR)

(72) Inventors: Sang-Jin WANG, Gyeonggi-do (KR); Bong-Do KIM, Gyeonggi-do (KR)

(73) Assignee: SAMSUNG ELECTRONICS CO., LTD., Gyeonggi-do (KR)

(21) Appl. No.: 13/684,777

(22) Filed: Nov. 26, 2012

(30) Foreign Application Priority Data
Dec. 2, 2011 (KR) 10-2011-0128625

(51) Int. Cl. G06F 3/02

(52) U.S. Cl. CPC G06F 3/0202
USPC 345/169

(57) ABSTRACT

A keypad fastening apparatus for a portable terminal includes: a housing; a keypad positioned on the housing; and a fastening arrangement configured to fasten the keypad to the housing, the fastening arrangement being positioned along the periphery of the keypad. In the fastening arrangement, a plurality of fasteners are attached to the housing and positioned at least in a part of the periphery of the keypad, in which each of the fasteners is provided with an anti-release part configured to prevent the vertical escaping of the keypad, which is caused when the keypad is pushed.

### CLAIM OF PRIORITY

This application claims the benefit under 35 U.S.C. §119(a) of a Korean patent application filed in the Korean Intellectual Property Office on Dec. 2, 2011 and assigned Serial No. 10-2011-0128625, the contents of which are hereby incorporated by reference.

### BACKGROUND

1. Field of the Invention

The present invention relates to a fastening apparatus, and more particularly, to a keypad fastening apparatus for fastening a keypad to a portable terminal

2. Description of the Related Art

In general, a portable terminal is an electronic device that allows a user to enjoy a multimedia service, for example storing various information items and enjoying games, moving pictures or the like, in addition to having a communication function, such as voice communication, message transmission or the like, all while being carried by a user. Such portable electronic devices are manufactured in various forms, for example an electronic scheduler, a palm personal computer (PC), a portable game machine, a moving picture/music file reproducer, a cellular phone, a notebook PC, etc.

Electronic schedulers and multimedia functions have been incorporated into portable terminals, such as a cellular phone, making it possible to enjoy a banking business, such as micropayment, and various contents, such as a game/multimedia service, in addition to the usual communication function, such as voice communication, with a portable terminal. That is, the early portable terminals merely provided voice communication and simple message transmission services. However, as electronic and telecommunication technologies have developed, which allow portable terminals to be gradually miniaturized and integrated, portable terminals are provided with a security function that enables a banking business, a multimedia function that allows a user to enjoy games, moving pictures or the like, and a business function including accessing Internet and transmission/reception of e-mails beyond the communication function inherent to the portable terminals.

With a conventional portable terminal, a keypad with numeral input keys, a talk/end key, a menu key, and a movement key were enough to conduct voice communication or to prepare a short message. However, as various functions are incorporated into such a portable terminal, a necessity to expand a keypad to accommodate such enhanced functions has arisen. It may be possible to provide more keys by reducing the size of each of the keys. However, if keys are too small, inconvenience may occur in that when a key is operated, another key adjacent to the key may be mistakenly operated. Therefore, a terminal has appeared recently, which is provided with a QWERTY keypad. The QWERTY keypad is configured by assembling two housings, and can be operated in a state in which the terminal is extended in its width.

As portable terminals are reduced in size to enhance portability, there is a problem in that it is difficult to maintain a sufficient keypad area.

Technology for such a keypad is disclosed in Korean patent laid-open publication No. 10-2008-0040915 entitled, “Keypad Coupling Structure for Portable Terminal,” and published on May 9, 2008, and Korean patent laid-open publication No. 10-2006-0119546 entitled, “Keypad with Protective Protrusion and Method of Manufacturing the Same,” and published on Nov. 24, 2006.

FIGS. 1-3 illustrate a keypad fixing apparatus for a conventional portable terminal. Referring to FIGS. 1-3, the conventional portable terminal 1 includes a keypad 20, and a housing 10 on which the keypad 20 is seated. The keypad 20 is formed from a rubber material. On the top side of the keypad 20, there is provided a plurality of key tops 21. If the portable terminal 1 is configured in a bar-type, the keypad 20 is arranged between a front case 11 and a rear case 12 of the housing 10 of the terminal 1. If the portable terminal 1 is configured in a slide-type or folder type, two housings 10 are slid or rotated in a folded state, a display unit 30 is mounted on the front housing, and a front keypad 20 is mounted on the rear housing. In particular, a slide-type portable terminal 1 may be provided with only a display unit 30 on the front housing. Alternatively, the slide-type portable terminal 1 may be provided with a display unit 30 and a keypad 20 with some function keys on the front housing, and another keypad 20 on the rear housing. Here, a portable terminal 1 including both a display unit 30 and a keypad 20 on a bar-type housing or front housing will be described by way of an example.

The front case 11 is provided with an opening 13 configured to expose key tops 21, and a window 14 configured to mount a display unit 30. The front case 11 is formed in a frame shape to wrap the edges of the keypad 20 and the edges of the display unit 30 around the opening 13 to fix them in the housing 10. On the inner face of the front case 11, a plurality of mounting protrusions 11a are formed to fix the keypad 20 along periphery of the opening 13. Each of the mounting protrusions 11a extends from the inner face of the front case 11 toward the rear case 12.

A binding rib 23a extends along the edges of the keypad 20, and binding holes 23b are formed in the binding rib 23a to be fixedly fastened to the mounting protrusions 11a, respectively. When the keypad 20 is assembled to the front case 11, the mounting protrusions 11a extend through the binding holes 23b to be bound to the binding holes 23b. As such, the keypad 20 is assembled in a predetermined position in relation to the front case 11, and can be arranged within the opening 13.

The key tops 21 protruding through the opening 13 are provided with a plurality of secondary keys, such as an end key, a cancel key and a talk key, and a 4-direction key 21a for executing or searching various multimedia functions, as well as numeric keys and letter keys. The 4-direction key 21a is arranged between the binding rib 23a and the numeric keys for purposes of a user's convenience, and executes various functions by being rotated or pushed at upper, lower, left and right parts thereof.

In order to allow the keypad 20 and the display unit 30 to be installed in the front case 11 to be exposed to the outside, the front case 11 should have a predetermined width configured to fasten the keypad 20 and the display unit 30 around the edges thereof.

However, in order for each of the display unit 30 and the keypad 20 to have a size as large as possible in the front case 11, which has a predetermined size, it is 30 necessary to form the width of the front case 11c to be as small as possible. In particular, since the 4-direction key 21a is formed adjacent to the binding rib 23a, it is unavoidable that the fastening force exerted by the binding holes 23b fastened to the mounting protrusions 11a adjacent to the 4-direction key 21a is deteriorated due to the constant use of the 4-direction key 21a. Furthermore, since the binding holes 23b are fixed in a state in which they are fitted on the mounting protrusions 11a vertically upward, the binding rib 23a formed adjacent to the 4-direction key 21a is moved from the upper side to the lower side together with the 4-direction key 21a as the 4-direction key 21a is multi-directionally pushed. Therefore, there is a problem in that a binding hole 23b fastened adjacent to the 4-direction key 21a may easily escape from the corresponding mounting protrusion 11a (see the figure illustrated in the lower part of FIG. 3) during the use of the 4-direction key 21a. That is, as the width of the front case 11 is narrowed, there is a problem in that the keypad 20 may be easily separated from the front case 11 when a user applies force to a position adjacent to the fastening area.

### SUMMARY

Accordingly, an aspect of the present invention is to solve the above-mentioned problems occurring in the prior art, and to provide a keypad fastening apparatus which is capable of preventing, when a width of a housing used to fasten a keypad is narrowed, the keypad from being removed from the housing when a key top positioned adjacent to the keypad fastening location is pushed by force.

In an exemplary embodiment of the present invention, there is provided a keypad fastening apparatus for a portable terminal, including: a housing; a keypad positioned an inner face of the housing; and a fastening arrangement configured to fasten the keypad to the housing, the fastening arrangement being positioned along the periphery of the keypad, wherein the fastening arrangement comprises a plurality of fasteners attached to the inner face of the housing and positioned at least in a part of the periphery of the keypad, each of the fasteners comprising an anti-release part configured to prevent the vertical escaping of the keypad from the housing, which is caused when the keypad is pushed.

In another aspect of the present invention, the keypad may be configured in a polygonal shape to have a plurality of edges.

In another aspect of the present invention, the keypad is provided with a substantially rectangular 4-direction key having four edges.

In another aspect of the present invention, each of the fasteners are positioned at a top edge of the keypad, the top edge being adjacent to a button array.

In another aspect of the present invention, each of the fasteners includes: a fastening part extending toward the keypad from the inner face of the housing; and the anti-release part angled from the tip end of the fastening part.

In another aspect of the present invention, the fastening arrangement includes a plurality of holders and the anti-release part of the fasteners extends substantially perpendicular from a tip end of the fastener to be caught by the holders to restrain the vertical escaping of the keypad fastened to the housing.

In another aspect of the present invention, the plurality of holders are attached to and extend around a periphery of the keypad and comprise a mounting piece and a mounting hole therethrough, wherein the mounting piece is made of an elastic material configured to extend around and over the anti-release part of the fastener.

In another aspect of the present invention, the anti-release part is positioned on a fastener positioned adjacent to a button arranged in the outermost area of the keypad.

In an exemplary embodiment of the present invention, there is provided a keypad fastening apparatus for a portable terminal, including: a housing; a display unit positioned on the housing; a keypad positioned on the housing and adjacent to the display unit; and a fastening arrangement configured to fasten the keypad to the housing, the fastening arrangement being positioned along an area between the display unit and the keypad, wherein the fastening arrangement comprises a plurality of fasteners attached to an inner face of the housing and positioned at least in a part of the periphery of the keypad, each of the fasteners comprising an anti-release part configured to prevent the vertical escaping of the keypad from the housing caused when the keypad is pushed.

In an aspect of the present invention, each of the fasteners are positioned at a top edge of the keypad, the top edge being adjacent to a button array.

In another aspect of the present invention, the keypad comprises a substantially rectangular 4-direction key having four edges.

In another aspect of the present invention, each of the fasteners are positioned adjacent to the 4-direction key.

In another aspect of the present invention, each of the fasteners includes: a fastening part extending toward the keypad from the inner face of the housing; and the anti-release part angled from the tip end of the fastening part.

In another aspect of the present invention, the fastening arraignment comprises a plurality of holders, wherein the anti-release part extends substantially perpendicular from the tip end of the fastening part to be caught by the plurality of holders to restrain the vertical escaping of the keypad fastened to the housing.

In another aspect of the present invention, at least one fastener is positioned adjacent to a button arranged in the outermost area of the keypad.

In an exemplary embodiment of the present invention, there is provided a keypad fastening apparatus for a slide-type portable terminal, including: a housing; a slide-type housing; a display unit positioned on the slide-type housing; a keypad positioned on the slide-type housing and adjacent to the display unit; and a fastening arrangement configured to fasten the keypad to the slide-type housing, the fastening arrangement being positioned along an area between the display unit and the keypad, wherein the fastening arrangement comprises a plurality of fasteners attached to the housing and positioned at least in a part of the periphery of the keypad, each of the fasteners comprising an anti-release part configured to prevent the vertical escaping of the keypad from the slide-type housing caused when the keypad is pushed.

In an aspect of the present invention, each of the fasteners are arranged adjacent to the top edge of the periphery of the keypad.

In an aspect of the present invention, the keypad comprises a substantially rectangular 4-direction key having four edges, wherein one edge is a top edge positioned substantially parallel with and closest to the area between the display unit and the keypad, and each of the fasteners having an anti-release part are arranged in the area between the display unit and the keypad at the top edge of the 4-direction key.

In an exemplary embodiment of the present invention, there is provided a keypad fastening apparatus, including: a housing; and a fastening arrangement attached to an inner face of the housing, wherein the fastening arrangement comprises a fastening part extending substantially perpendicular from the inner face of the housing, and an anti-release part angled from a tip end of the fastening part.

### BRIEF DESCRIPTION OF THE DRAWINGS

The above and other aspects, features and advantages of the present invention will be more apparent from the following detailed description taken in conjunction with the accompanying drawings, in which:

FIG. 1 is an exploded perspective view schematically illustrating a conventional portable terminal;

FIG. 2 illustrates a state in which a keypad is fastened to the housing in the conventional portable terminal;

FIG. 3 illustrates partially sectioned perspective views taken along line A-A′ in FIG. 2;

FIG. 4 is an exploded perspective view schematically illustrating a rear portion of a portable terminal in accordance with an embodiment of the present invention;

FIG. 5 is a cross-sectional top view illustrating a state in which a keypad is mounted in the front frame of FIG. 4;

FIG. 6 is a cross-sectional view illustrating a keypad holder of the front frame of FIG. 4, specifically an upper side holder;

FIG. 7 is a cross-sectional view taken along line B-B′ of FIG. 5;

FIG. 8 is a real side view illustrating the fastened state of the portable terminal of FIG. 4; and

FIG. 9 is a partially sectioned perspective view taken along line B-B′ of FIG. 5.

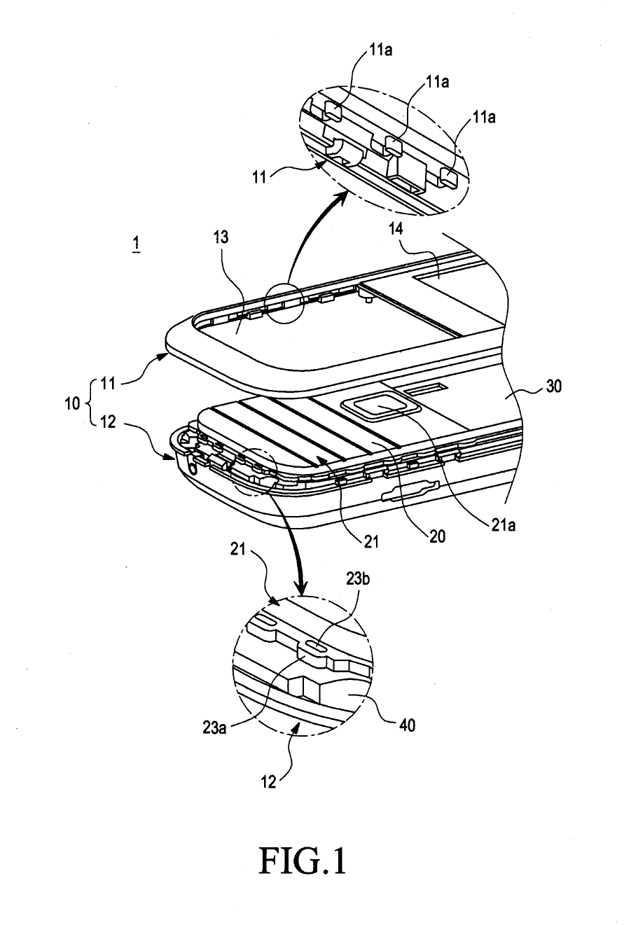

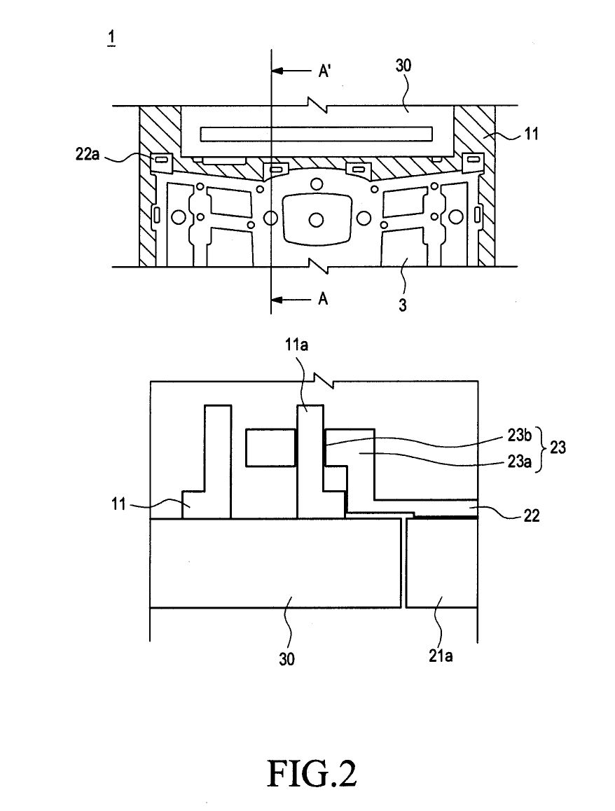

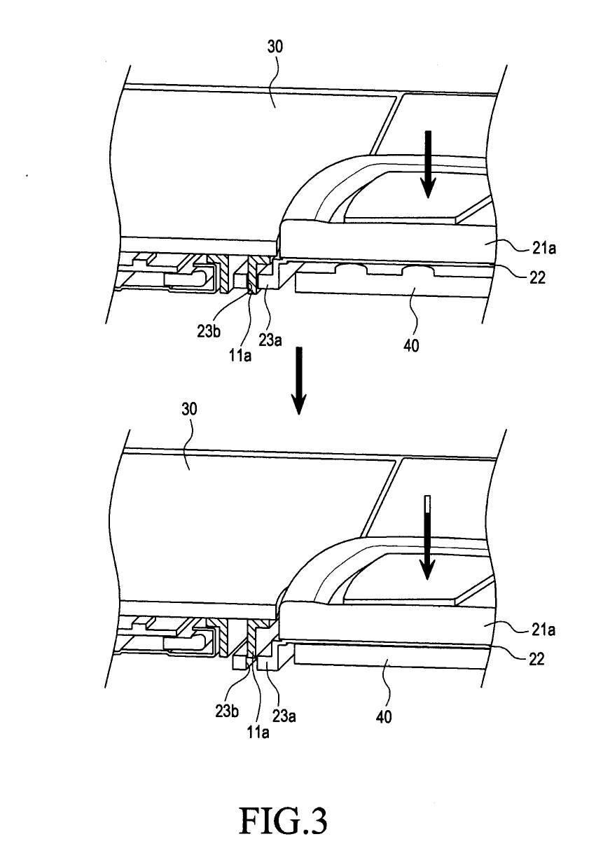

### DETAILED DESCRIPTION OF EXEMPLARY EMBODIMENTS

Hereinafter, exemplary embodiments of the present invention will be described with reference to the accompanying drawings. The thicknesses of lines in the drawings or the sizes of components may be exaggeratedly illustrated in the drawings for the purpose of clarity and convenience of description. Further, various terms found in the following description are those defined in consideration of functions in the present invention, and may be differently used in accordance with an intention of a user or operator, or practice. Therefore, the definitions for such terms should be made on the basis of the contents provided throughout the specification.

Although ordinal numbers, such as first and second, are used herein, they are used merely to distinguish identically named objects from each other, and the order may be arbitrarily determined. A description for a preceding object may be applied to an object described later.

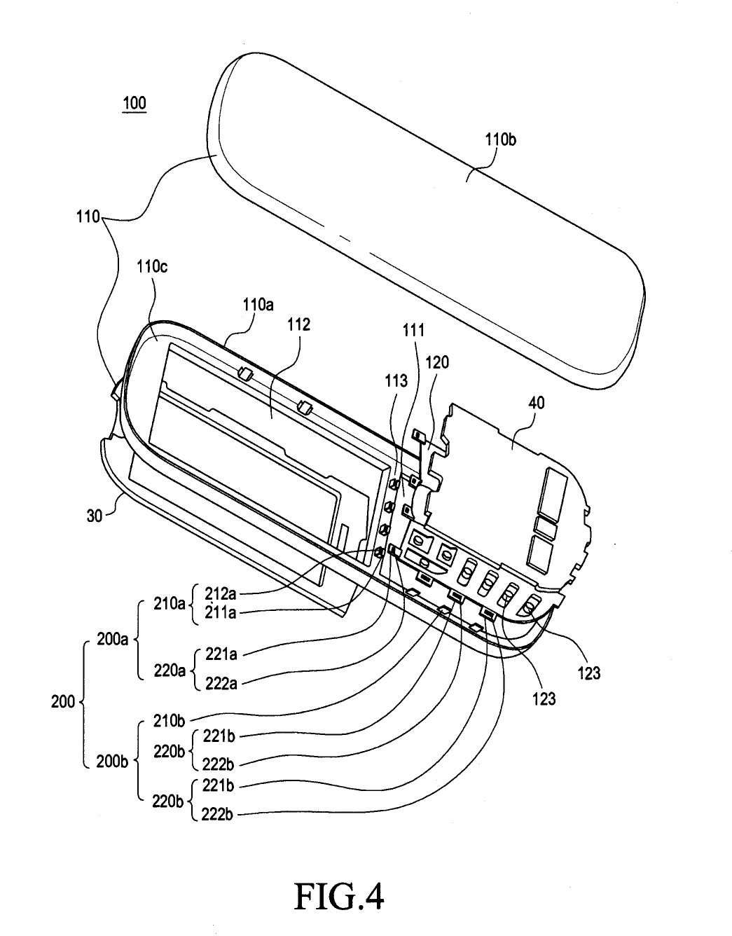

FIG. 4 is a schematic exploded perspective view of a rear portion of a portable terminal that is provided with a keypad fastening apparatus in accordance with an embodiment of the present invention.

The portable terminal 100 includes a housing 110, a display unit 30 arranged on the front side of the housing 110, a keypad 120, a printed circuit board 40, on which the keypad 120 is mounted, and a display unit bracket. In addition, the keypad fastening apparatus of the portable terminal 100 includes fasteners 200 for fastening the keypad 120 to the housing 110.

The housing 110 includes an inner surface 100c of a front frame 110a, on which the keypad 120 is mounted to be exposed to the outside of the housing. In the present embodiment, among a bar-type terminal and a slide-type terminal in which a display unit 30 and a keypad 120 are provided on one housing 110, the slide-type terminal, which is provided with a display unit 30 and a keypad 120 on a front housing 110 (corresponding to a slide-type housing 110 in a slide-type terminal and also referred to as a “housing 110” below), will be described by way of example. However, the housing, to which the present invention is applicable, is not limited to the slide-type housing 110. The present invention is alternatively applicable to a housing 110 if the housing 110 is formed with an opening 111 to mount a keypad 120 without a display unit 30. This can be accomplished in, for example, a housing 110 of a folder-type terminal which is provided with a keypad 120 only, and a rear housing 110 of a slide-type terminal which is provided with a keypad 120 only.

The front frame 110a is formed with an opening 111 and a window 112 in which the keypad 120 and the display unit 30 are installed to be exposed, respectively. A separation frame part 113 configured to separate the display unit 30 and the keypad 120 is formed between the opening 111 and the window 112, in which the separation frame part 113 is configured to fasten the top edge of the keypad 120. If the housing 110 is configured to be provided with a keypad 120 and without a display unit 30 due to the type of terminal being used, the edges of the keypad 120 are fastened to the inner surface 110c of the front frame 110a along the periphery of the opening 111. The front frame 110a is configured to be closed when it is engaged with a display unit bracket (not illustrated). The display unit bracket will be described below. A rear case 110b is fastened to the front frame 110a, and the display unit 30, the keypad 120, the display unit bracket, and a printed circuit board 40 are provided between the front frame 110a and the rear case 110b. A receiver unit (not illustrated) is provided above the display unit 30, and a transmitter unit (not illustrated) is provided below the keypad 120.

Fasteners 210a and 210b are provided on the inner face 110c of the front frame 110a along the periphery of the opening 111. The periphery of the keypad 120 is positioned against and fastened to the housing 110a by the fasteners 210a and 210b. The fasteners 210a and 210b are provided on the front frame 110a as components of a fastening arrangement 200 to fasten the keypad 120 and the front frame 110a to one another. The fasteners 210a and 210b will be described below as a part of the fastening arrangement 200.

The keypad 120 is mounted on the printed circuit board 40, the printed circuit board 40 being provided within the housing 110. The keypad 120 includes a button array 121 and an actuation member 122.

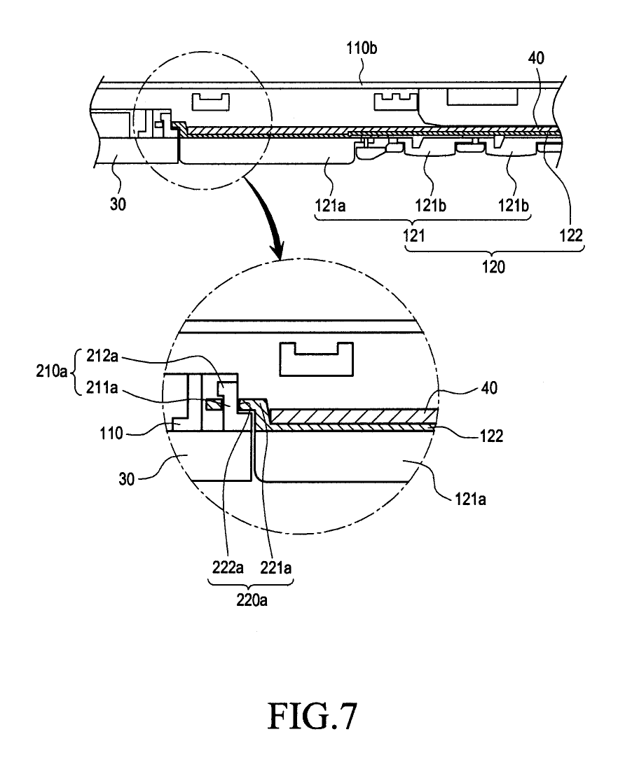

The button array 121 is exposed through the opening 111 of the front frame 110a. The button array 121 includes one or more buttons 121b which allow a user to input various data by pushing the buttons 121b. The button array 121 is seated on the top of the actuation member 122 (see FIGS. 7 and 9). The button array 121 is exposed to the top side of the front frame 110a through the opening 111. In addition, marginal areas extending from the actuation member 122 are fastened to the inner face 110c of the front frame 110a along the periphery of the opening 111. The button unit 121 on the keypad 120 may include a plurality of buttons 121b, for example, 3×4 keys or QWERTY keys, and a polygonal 4-direction key 121a. The keys are exposed to the front side of the keypad 120.

The rectangular 4-direction key 121a has four edges, and a first fastener array 200a is positioned adjacent to the top edge of the four edges of the 4-direction key 121a. The first fastener array 200a will be described later. With this arrangement, the first fastener array 200a adjacent to the top edge is capable of preventing the keypad 120 from vertically escaping from the front frame 110a which may be caused when the 4-direction key 121a is pushed as described above.

Other buttons 121b arranged at the outermost area of the keypad 120 in the button array 121 and the 4-direction key 121a are positioned adjacent to the fasteners 210a and 210b. An anti-release part 212a may be provided on each of the fasteners 210a positioned adjacent to the buttons 121b and the 4-direction key 121a. The anti-release part 212a provided on each of the fasteners 210a will be described later by way of an example.

The button array 121 is mounted on the top side of the actuation member 122. The actuation member 122 is formed with a plurality of actuation bumps 123 on the bottom side thereof to be capable of transferring a pushing action to a key switch (not illustrated) on the printed circuit board 40. The actuation member 122 is formed of a flexible material having elasticity, such as silicon or urethane, so that it can be deformed as the buttons 121b are pushed. In the present embodiment, the keypad 120 is configured to have a polygonal shape with a plurality of edges, for example, to have a rectangular shape with four edges and to include a rectangular 4-direction key 121a, by way of an example. However, the shape of the keypad 120 is not limited to this, and may have various shapes depending on the shape of the front frame 110a, on which the keypad 120 is mounted, or the function of the 4-direction key 121a.

In addition, holders 220a and 220b forming the fastening arrangement 200 to be described later are also provided. The holders 220a and 220b arranged along the edges of the actuation member 122 will be described by way of an example. However, the holders 220a and 220b are not limited to this. For example, the configuration and shape of the keypad 120 may be variously modified if the holders 220a and 220b are configured or shaped along the edges of the keypad 120 to be suitable for the shape of the keypad 120 or components assembled thereto, and the holders 220a and 220b can be fastened to the fasteners 210a and 210b, respectively, in such a manner that the vertical escaping thereof can be prevented by the fasteners 210a and 210b.

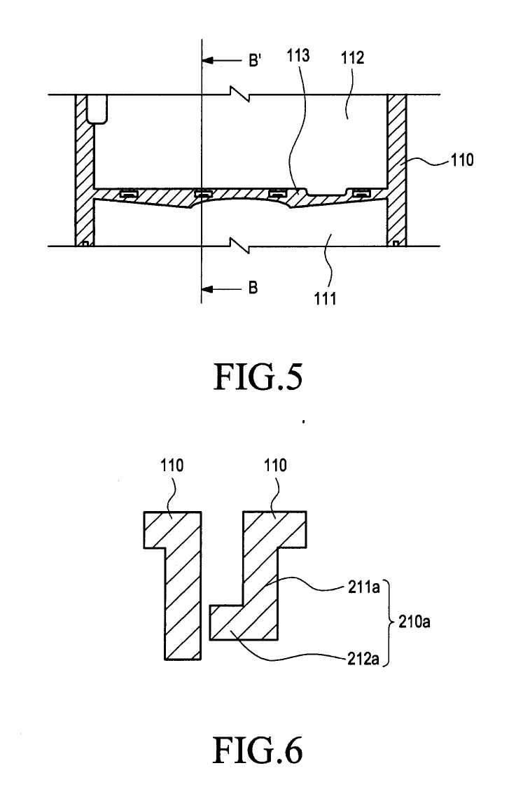

FIG. 5 schematically illustrates a top view of a part of a housing provided with fasteners forming a fastening arrangement in the keypad fastening apparatus in accordance with the present embodiment, and FIG. 6 illustrates a cross-sectional view taken along line B-B′ in FIG. 5.

Referring to FIGS. 5-6, the keypad 120 and the front frame 110a include a fastening arrangement 200 for fastening the keypad 120 to the front frame 110a.

The fastening arrangement 200 is provided on the keypad 120 and the front frame 111a to fasten the keypad 120 to the front frame 110a. The fastening arrangement 200 is provided to prevent the vertical escaping of the keypad 120, more particularly, to prevent the keypad 120 from escaping in the pushed direction of the keypad 120 (vertically downward) when the keypad 120 is pushed. Herein, in the fastening arrangement 200, a fastener array positioned to correspond to a top edge of the keypad 120 will be referred to as a first fastener array 200a.

The first fastener array 200a is substantially equal to the counterpart fastener array 200b (hereinafter, referred to as a “second fastener array”) in terms of configuration and function. However, the first fastener array 200a and the second fastener array 200b are different from each other depending on whether an anti-release part 212a is provided on each of the fasteners 210a and 210b therein. That is, each of the fasteners 210a in the first fastener array 200a is provided with an anti-release part 212a but each of the fasteners 210b of the second fastener array 200b is not provided with such an anti-release part 212a. For example, the fastening arrangement 200 for fixing the keypad 120 includes first and second fastener arrays 200a and 200b. Here, the first fastener array 200a includes first fasteners 210a and first holders 220a, and the second fastener array 200b includes second fasteners 210b and second holders 220b. The first holders 220a and the second holders 220b are arranged around the edges of the keypad 120. The ordinal numbers, such as “first” or “second” are added to the terms of the holders 220a and 220b depending on which of the first and second fasteners 210a, 210b the holders 220a and 220b are engaged with, respectively. However, the first and second holders 220a, 220b may be equal to each other in view of configuration, type and shape.

However, the first fasteners 210a and the second fasteners 210b are different from each other in view of their different configuration. Although the first fasteners 210a and the second fasteners 210b are both provided on the inner face 110c of the front frame 110a, they are differentiated from each other based on whether they are provided with an anti-release part 212a. That is, each of the second fasteners 210b is comprised only of the fastener 210b itself, but each of the first fasteners 210a includes both a fastening part 211a and an anti-release part 212a angled substantially horizontally from the tip end of the fastening part 211a.

FIG. 7 is a cross-sectional view illustrating a state in which a keypad is mounted in the front frame in the portable terminal of FIG. 5, and an enlarged view illustrating a part of the cross-sectional view in an enlarged scale.

The fastening arrangement 200 includes fasteners 210a and 210b, and holder parts 220a and 220b, as described above. The fasteners 210a and 210b are formed on the front frame 110a. More specifically, the fasteners 210a and 210b are provided on the inner face 110c of the front frame along the periphery of the opening 111, and protrude toward the keypad 120 from the inner face 110c of the front frame 110a. The holders 220a and 220b of the keypad 120 are fastened to the fasteners 210a and 210b, respectively. Among the fasteners 210a and 210b, each of the fasteners 210a (“first fasteners”) positioned at, in this example, a top edge of the keypad 120 is provided with an anti-release part 212a to prevent the keypad 120 from escaping vertically when the keypad 120 is pushed. Both the first fasteners 210a and the second fasteners 210b extend from the inner face of the front frame 110a. However, unlike the second fasteners 210b, each of the first fasteners 210a includes a fastening part 211a extending from the inner face of the front frame 110a and an anti-release part 212a angled substantially horizontally from the tip end of the fastening part 211a. Here, a first fastener 210a positioned adjacent to a top edge of the keypad 120 means a fastener located at a position where an action of pushing the button unit affects the ability of the fastener to fasten the keypad to the housing when the button array 121 and the fastening arrangement 200 are positioned very closely to each other, i.e. when the button array 121 is adjacent to the fastening arrangement 200 to such an extent that the button array 121 and the fastening arrangement 200 are almost in contact with each other (for example, in the button array 121, the 4-direction key 121a is most closely arranged to the fastening arrangement 200 and to such an extent that an end of the 4-direction key 121a is arranged adjacent to an edge of the front frame 110a after the keypad 120 is mounted on the front frame 110a).

If the fastening arrangement 200 is not affected by an action of pushing the button array 121 although the button array 121 is adjacent to the fastening arrangement 200 due to a relatively wide area on the front frame 110a, to which the keypad 120 is fastened, the second fasteners 210b may be formed on the corresponding edge of the keypad 120 in that area.

In the present embodiment, it is described, by way of an example, that the first fasteners 210a, each of which includes a fastening part 211a and an anti-release part 212a, are only provided on the separation frame part 113 of the front frame 110a or on the top area of the front frame 110a adjacent to the 4-direction key 121a. However, the present invention is not limited to this. For example, if the buttons 121b arranged at the laterally outermost portions of the keypad 120 are positioned adjacent to the fastening arrangement 200 to such an extent that an action of pushing a button 121b affects the fastening arrangement 200, it is also possible to provide the first fasteners 210a, each of which has the anti-release part 212a, on the opposite lateral areas of the front frame 110a to prevent the fastening arrangement 200 from being affected by the pushing action. Therefore, if there is a likelihood that the keypad 120 will experience vertical displacement or escape when an edge of the keypad 120 is pushed, it is possible to form all of the fasteners positioned adjacent to the edge as the first fasteners 210a, each of which having the anti-release part 212a. Alternatively, it is also possible to form some of the fasteners as the first fasteners 210a, and to form the remaining fasteners as the second fasteners 210b. Therefore, it is possible that the first fasteners 210a may be provided at any of the positions provided for the fasteners on the front frame 110a if the positions are adjacent to an edge of the keypad 120.

As described above, each of the first fasteners 210a includes a fastening part 211a and an anti-release part 212a, and each of the second fasteners 210b includes a fastening part 211a only. The first fasteners 210a and the second fasteners 210b are arranged around the opening 111 and extend toward the keypad 120 from the inner face 110c of the front frame 110a.

Each of the fastening parts 211a is configured as a protrusion extending to the inside of the front frame 110a from the inner face 110c of the front frame 110a, and inserted into and fastened to a first mounting hole 222a (to be described later) of holder 220a.

Each of the protrusion-shaped fastening parts 211a is provided with an anti-release part 212a at the tip end thereof to prevent the first mounting hole 222a fastened to the protrusion-shaped fastening part 211a from releasing the protrusion-shaped fastening parts 211a when a button 121b positioned adjacent to the first fastener array 200a is pushed. The anti-release part 212a is formed to be angled substantially horizontally/perpendicularly from the tip end of the protrusion-shaped fastening part 211a. Even if the first mounting hole 222a is moved vertically downward along the protrusion-shaped fastening part 211a as the corresponding button 121b is pushed, the protrusion-shaped fastening part 211a is prevented from vertically escaping from the mounting hole 222a as the mounting piece 221a is caught by the horizontally angled protrusion 212a.

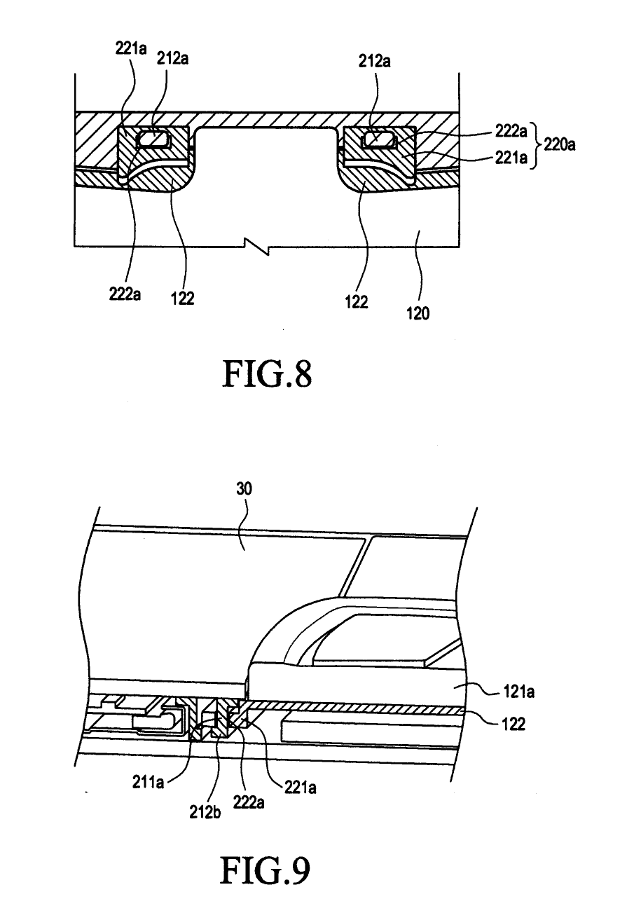

FIG. 8 is a view illustrating a state in which the keypad is fastened to the front frame in the keypad fastening apparatus in accordance with an embodiment of the present invention, and FIG. 9 is a partially sectioned perspective view taken along line B-B′ of FIG. 5.

Referring to FIGS. 8 and 9, the holders 220a and 220b are formed to extend around the edges of the keypad 120, so that the fasteners 210a and 210b can be fitted in and vertically fastened to the holders 220a and 220b, respectively. Each of the holders 220a or 220b includes a mounting piece 221a or 221b, and a mounting hole 222a or 222b.

The holders 220a and 220b may be classified into first holders 220a and second holders 220b. Therefore, although ordinal numerals, such as “first” and “second,” are added to the terms thereof depending on whether they are fastened to the first fasteners 210a or the second fasteners 210b as described above, they are equal to each other in view of configuration, type and shape. Therefore, although the first holders 220a are described in the present embodiment by way of an example, the second holders 220b are identical to the first holders 220a except the positions thereof on the keypad 120. Therefore, a description for the second holders 220b will be omitted.

The mounting pieces 221a and 221b extend outward around edges of the keypad 120, more particularly, they extend outward around the edges of the actuation member 122. The mounting pieces 221a and 221b are provided to correspond to the fasteners 210a and 210b in position, respectively. When the mounting holes 222a and 222b to be described later are fitted on and fastened to the fasteners 210a and 210b, the mounting pieces 221a and 221b are parallel with and come into close contact with the inner face 110c of the front frame 110a, and the keypad 120 is fastened to the front frame 110a. The mounting holes 222a and 222b are formed through the mounting pieces 221a and 221b, respectively. The fasteners 210a and 210b are fitted in and vertically fastened to the mounting holes 222a and 222b, respectively.

Among the holders 220a and 220b, holders 220a (“first holders”) adjacent to the 4-direction key 121a are fastened to the first fasteners 210a, respectively. Each of the first holders 220a includes a first mounting piece 221a and a first mounting hole 222a (each of the second holders 220b includes a second mounting piece 221b and a second mounting hole 222b). That is, each of the first mounting pieces 221a of the first holders 220a is fastened to one of the first fasteners 210a. Each of the first mounting holes 222a formed in the first mounting pieces 221a is fitted over one of the horizontally angled anti-release part 212a and fastened to the protrusion-shaped fastening part 211a following the horizontally angled anti-release part 212a. The protrusion-shaped fastening part 211a extends through the first mounting holes 222a to fasten the first mounting piece 221a parallel to the inner face 110c of the front frame 110a. The first mounting piece 221a is caught by the horizontally angled anti-release part 212a at the bottom side thereof, which limits the vertical movement of the first mounting piece 221a. That is, as the 4-direction key 121a arranged adjacent to the first mounting pieces 222a is pushed, the first mounting piece 221a may be moved along the protrusion-shaped fastening part 211a. However, the additional movement of the first mounting piece 221a is restrained by the horizontally angled anti-release part 212a. Therefore, even if an excessive force is applied to the 4-direction key or an area adjacent thereto as a user excessively pushes the 4-direction key 121a or applies an excessive vertical force to the keypad 120, the vertical escaping of the protrusion-shaped fastening part 211a out of the first mounting hole 222a can be prevented. As a result, unless damage is produced, for example, the mounting hole is fractured, the fastening between the first holder 220a and the first fastener 210a can be maintained without being released.

Here, each of the first and second mounting pieces 221a and 221b extending from the flexible actuation member 122 is also formed from a flexible material with elasticity. As a result, when any of the first mounting holes 222a is fastened to the corresponding protrusion-shaped fastening part 211a over the horizontally angled anti-release part 212a, the first mounting hole 222a is elastically extended and then returned to its original size enabling the mounting pieces 221a and 221b to stretch over and around the horizontally angled anti-release part 212a. When the first mounting hole 222a is fastened to the protrusion-shaped fastening part 211a by being fitted over the horizontally angled anti-release part 212a, the first mounting piece 221a is parallel with and comes into close contact with the inner face 110c of the front frame 110a.

Now, a process for fastening the keypad 120 configured as described above to a front frame 110a will be briefly described.

The keypad 120 is positioned in such a manner that the button array 121 is exposed through the opening of the front frame 110a. The fasteners provided on the inner face 110c of the front frame 110a along the periphery of the opening 111 are engaged with the holders, respectively.

That is, the first and second mounting holes 222a and 222b are fitted on and fastened to the first and second fasteners 210a and 210b, which extend toward the keypads 120 from the inner face 110c of the front frame 110a. At this time, the first mounting holes 222a are elastically extended in size, moved over the horizontally angled anti-release parts 212a, and then returned to the original size thereof causing the first mounting holes 222a to be fastened to the protrusion-shaped fastening parts 211a, respectively. Therefore, the first mounting holes 222a are prevented from being moved vertically downward by the horizontally angled anti-release parts 212a, respectively.

As the first fasteners 210a are fastened to the first holders 220a, and the second fasteners 210b fastened to the second holders 220b, the keypad 120 is fixedly mounted on the front frame 110a.

When a button 121b exposed through the opening 111 of the front frame 110a is pushed (in particular, when a button 121b adjacent to the fastening arrangement 200 is frequently pushed), one or more first holders 220a affected by the action of pushing the button 121b do not escape from the corresponding first fasteners 210a due to the horizontally angled anti-release parts 212a.

While the invention has been illustrated and described with reference to certain exemplary embodiments thereof, it will be understood by those skilled in the art that various changes in form and details may be made therein without departing from the spirit and scope of the invention as defined by the appended claims.

For example, as described above, one or more horizontally angled anti-release parts 212a may be provided at any location of a front frame 110a if an area provided for fastening the keypad 120 has a narrow width and it is necessary to provide the horizontally angled anti-release parts 212a at that particular location to prevent the keypad 120 from escaping when a button part 121 is pushed.

Besides a portable terminal, the inventive keypad fastening apparatus may be applied to any electronic device, for example, an electronic dictionary, an electronic scheduler or the like, in order to prevent a keypad (corresponding to the above-mentioned keypad 120) from escaping from a housing (corresponding to the above-mentioned housing 110) in the electronic device when a data input device is provided adjacent to the outer face of a keypad like the above-mentioned button array 121 and a fastening area between the keypad and a front frame (corresponding to the above-mentioned front frame 110a) has a very narrow width.

In accordance with the present invention, since a mounting hole is fitted on a protrusion-shaped fastening part and fixed by an anti-release part, it is possible to prevent the protrusion-shaped fastening part from escaping from the mounting hole by a vertical force applied when the keypad is pushed.

In addition, since a mounting hole is fixed by an anti-release part even when the mounting hole is vertically fitted on a protrusion-shaped fastening part in a state in which an area for fastening the keypad to the housing is narrowed, the fastening force can be increased.

In addition, since a mounting hole of a holder adjacent to a button is prevented from being pushed out of the fastener by an anti-release part of the fastener even if the button is positioned adjacent to the fastener to such an extent that the mounting hole adjacent to the button is moved to the tip end of the protrusion-shaped fastening part of the fastener when the button is pushed, it is possible to prevent the keypad from being released from the housing.

In addition, with a simple construction of anti-release parts, each of which is formed to be angled from the tip end of a protrusion-shaped fastening parts, it is possible to prevent the keypad from escaping from the housing. In addition, it is not required to pay additional material costs for preventing the escaping of the keypad, and it is possible to improve the reliability of the keypad.

What is claimed is:

1. A keypad fastening apparatus for a portable terminal, comprising:
a housing;
a keypad positioned on an inner face of the housing; and
a fastening arrangement configured to fasten the keypad to the housing, the fastening arrangement being positioned along the periphery of the keypad, wherein the fastening arrangement comprises a plurality of fasteners attached to the inner face of the housing and positioned at least in a part of the periphery of the keypad, each of the fasteners comprising an anti-release part configured to prevent the vertical escaping of the keypad from the housing caused when the keypad is pushed.

2. The keypad fastening apparatus as claimed in claim 1, wherein the keypad is configured in a polygonal shape comprising a plurality of edges.

3. The keypad fastening apparatus as claimed in claim 2, wherein the keypad comprises a substantially rectangular 4-direction key having four edges.

4. The keypad fastening apparatus as claimed in claim 1, wherein each of the plurality of fasteners are positioned at a top edge of the keypad, wherein the top edge of the keypad is adjacent to a button array.

5. The keypad fastening apparatus as claimed in claim 4, wherein each of the plurality of fasteners comprises:
a fastening part extending toward the keypad from the inner face of the housing; and
the anti-release part angled from a tip end of the fastening part.

6. The keypad fastening apparatus as claimed in claim 5, wherein the fastening arrangement further comprises a plurality of holders, and wherein the anti-release part of each of the plurality of fasteners extends substantially perpendicular from the tip end of the fastening part to be caught by each of the plurality of holders to restrain the vertical escaping of the keypad fastened to the housing.

7. The keypad fastening apparatus as claimed in claim 6, wherein the plurality of holders comprise a mounting piece and a mounting hole therethrough, and wherein the plurality of holders extend around and are attached to the periphery of the keypad.

8. The keypad fastening apparatus as claimed in claim 7, wherein the mounting piece is comprised of an elastic material enabling the mounting holders to stretch over and around the anti-release part of each of the plurality of fasteners.

9. The keypad fastening apparatus as claimed in claim 5, wherein at least one fastener is positioned adjacent to a button arranged in the outermost area of the keypad.

10. A keypad fastening apparatus for a portable terminal, comprising:
a housing;
a display unit positioned on the housing;
a keypad positioned on an inner face of the housing and adjacent to the display unit; and
a fastening arrangement configured to fasten the keypad to the housing, the fastening arrangement being positioned along an area between the display unit and the keypad, wherein the fastening arrangement comprises a plurality of fasteners attached to the inner face of the housing and positioned at least in a part of the periphery of the keypad, wherein each of the plurality of fasteners comprises an anti-release part configured to prevent the vertical escaping of the keypad from the housing caused when the keypad is pushed.

11. The keypad fastening apparatus as claimed in claim 10, wherein each of the plurality of fasteners is positioned at a top edge of the keypad, wherein the top edge of the keypad is adjacent to a button array.

12. The keypad fastening apparatus as claimed in claim 11, wherein the keypad comprises a substantially rectangular 4-direction key having four edges.

13. The keypad fastening apparatus as claimed in claim 12, wherein each of the plurality of fasteners is positioned adjacent to the 4-direction key.

14. The keypad fastening apparatus as claimed in claim 13, wherein each of the plurality of fasteners comprises:
a fastening part extending toward the keypad from the inner face of the housing; and
the anti-release part angled from a tip end of the fastening part.

15. The keypad fastening apparatus as claimed in claim 14, wherein the fastening arrangement further comprises a plurality of holders, wherein the anti-release part of each of the plurality of fasteners extends substantially perpendicular from the tip end of the fastening part to be caught by the plurality of holders to restrain the vertical escaping of the keypad fastened to the housing.

16. The keypad fastening apparatus as claimed in claim 10, wherein at least one fastener of the plurality of fasteners is positioned adjacent to a button arranged in the outermost area of the keypad.

17. A keypad fastening apparatus for a slide-type portable terminal, comprising:
a housing;
a slide-type housing;
a display unit positioned on the slide-type housing;
a keypad positioned on the slide-type housing and adjacent to the display unit; and
a fastening arrangement configured to fasten the keypad to the slide-type housing, the fastening arrangement being positioned along an area between the display unit and the keypad, wherein the fastening arrangement comprises a plurality of fasteners attached to the housing and positioned at least in a part of the periphery of the keypad, wherein each of the plurality of fasteners comprises an anti-release part configured to prevent the vertical escaping of the keypad from the slide-type housing caused when the keypad is pushed.

18. The keypad fastening apparatus as claimed in claim 17, wherein each of the plurality of fasteners are arranged adjacent to a top edge of the periphery of the keypad.

19. The keypad fastening apparatus as claimed in claim 18, wherein the keypad comprises a substantially rectangular 4-direction key having four edges, wherein one edge is a top edge positioned substantially parallel with and closest to the area between the display unit and the keypad, and each of the plurality of fasteners having an anti-release part are arranged in the area between the display unit and the keypad at the top edge of the 4-direction key.

20. A keypad fastening apparatus, comprising:
a housing; and
a fastening arrangement attached to an inner face of the housing, wherein the fastening arrangement comprises:
a fastening part extending substantially perpendicular from the inner face of the housing, and
an anti-release part angled from a tip end of the fastening part.
